(19) United States
(12) Patent Application Publication
(10) Pub. No.: US 2007/0215441 A1
(43) Pub. Date: Sep. 20, 2007

(54) Timed Light Switch

(76) Inventor: Shary Nassimi, Malibu, CA (US)

Correspondence Address: BOND, SCHOENECK & KING, PLLC, ONE LINCOLN CENTER, SYRACUSE, NY, 13202-1355, US

(21) Appl. No.: 11/308,261

(22) Filed: Mar. 14, 2006

(51) Int. Cl. H01H 21/00

(52) U.S. Cl. 200/6 R

(57) ABSTRACT

A switch including a housing, a face plate having a slot formed therethough, and a rocker that extends from housing for manually activating and controlling the load applied to an electrical circuit. The rocker is biased to be in a center or neutral position and when a user presses on side of the rocker, circuitry contained within the housing switches on the electrical load for a predetermined period of time. Manual movement of the rocker into the first position for a second time switches on the electrical load for a second predetermined period of time. Manual movement of the rocker into the second position turns off the electrical load. The switch also includes mechanisms allowing a user to adjust the first and second predetermined time periods.

### BACKGROUND OF THE INVENTION

1. Field of Invention

The present invention relates to light switches and, more specifically, to a light switch having a built-in time.

2. Description of Prior Art

Conventional timer switches generally include a timer interconnecting a manually operated switch and the electrical load. When the switch is activated, the timer is set for a predetermined period of time and the load is applied to the underlying circuit. When the timer expires, the load is removed from the underlying circuit.

While these switches provide for timed application of current to a circuit, such as a light, they are limited in their flexibility as they only provide for a single, finite duration without significant interaction by the user. Once turned on, these switches must also stay on for the entire predetermined time as they typically lack any form of override feature. In addition, these switches are only capable of measuring a single time period at a time.

### SUMMARY OF THE INVENTION

It is a principal object and advantage of the present invention to provide a timed switch having adjustable time periods.

It is an additional object and advantage of the present invention to provide a timed switch capable of easily handling multiple time periods.

It is a further object and advantage of the present invention to provide a timed switch having an override feature.

Other objects and advantages of the present invention will in part be obvious, and in part appear hereinafter.

In accordance with the foregoing objects and advantages, the present invention comprises a switch including a housing, a face plate having a slot formed therethough, and a rocker that extends from housing for manually activating and controlling the load applied to an electrical circuit. The rocker is biased by a spring to be in a center or neutral position and is moveable into a first position by depressing one end of rocker, or a second position by depressing the opposing end of rocker. Movement of the rocker into the first position activates circuitry contained within the housing that switches on the electrical load for a predetermined period of time. Movement of the rocker into the first position for a second time optionally switches on the electrical load for a second predetermined period of time. Movement of the rocker into the second position turns off the electrical load. Preferably, the switch includes mechanisms allowing a user to adjust the first and second predetermined time periods.

### BRIEF DESCRIPTION OF THE DRAWINGS

The present invention will be more fully understood and appreciated by reading the following Detailed Description in conjunction with the accompanying drawings, in which:

FIG. 1 is a perspective view of a switch according to the present invention.

FIG. 2 is a front view of a switch according to the present invention.

FIG. 3 is a schematic of the circuitry of a switch according to the present invention.

FIG. 4 is a flowchart of the process implemented by a switch according to the present invention.

### DETAILED DESCRIPTION

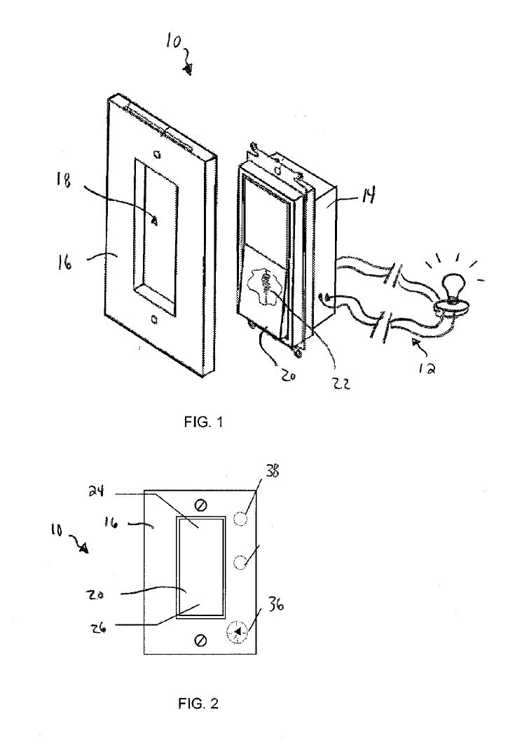

Referring to the drawings, wherein like numerals refer to like parts throughout, there is seen in FIG. 1 a timed light switch 10 according to the present invention for controlling an electrical circuit 12, such as a household light. Switch 10 has the same dimensions as a conventional light switch and is wired to electrical circuit 12 in the conventional manner.

Switch 10 comprises a housing 14, a face plate 16 having a slot 18 formed therethough, and a rocker 20 that extends from housing 22 through slot 18 of face plate 16. Referring to FIG. 2, switch 12 further comprises a spring 22 or comparable biasing element for maintaining rocker in a center or neutral position if rocker 20 is moved to either a first position 24 by depressing one end of rocker 18, or a second position 28 by depressing the opposing end of rocker 18.

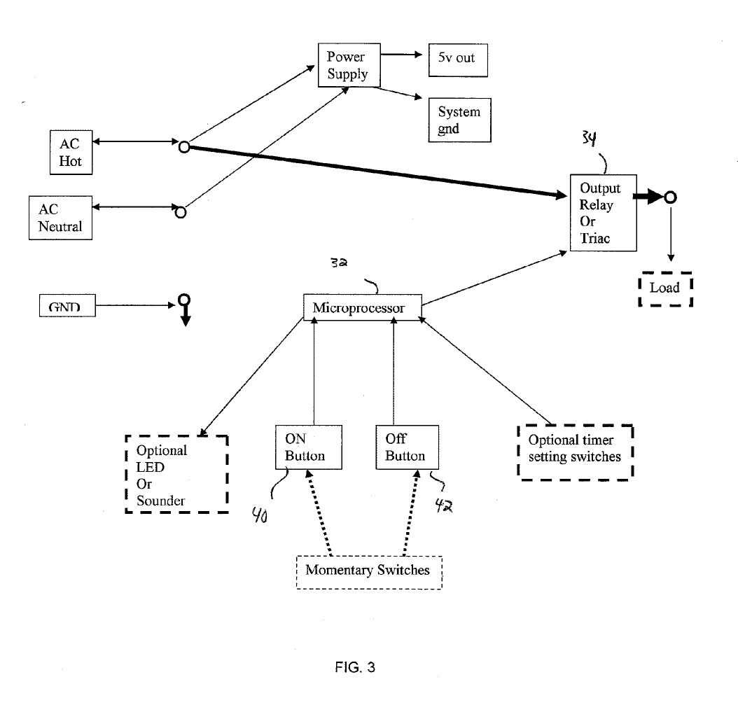

Movement of rocker 20 to first position 24 activates circuitry contained within housing 14 which controls the application of an electrical load to electrical circuit 12 controlled by switch 10. Referring to FIG. 3, housing 14 include a microprocessor 32 for controlling the application of current to circuit 12 via a relay 34.

When rocker 20 is moved to first position 24, load is applied to the electrical circuit for a predetermined period of time, e.g., one hour. The time during which the load is applied is measured by microprocessor 32. It should be obvious to one of skill in the art that microprocessor 32 may be programmed to determine any useful time period using conventional clock and counter functions. Microprocessor 32 may further be programmed to measure a second predetermined time period (e.g., five hours) activated by movement of rocker 20 to first position 24 sometime after circuit 12 has been energized. The load applied to electrical circuit 12 by switch 10 is removed by microprocessor 32 via relay 34 after expiration of the first time period and, if applicable, the expiration of the second time period.

Housing 14 may further include one or more adjustment mechanisms 36, such as pot or rotary switches, that allow a user to adjust the first and/or second time periods measured by microprocessor 32. The load applied to electrical circuit 12 may also be disengaged by manually moving rocker 20 to second position 28. Switch 10 optionally includes one or more visual indicators 38, such light emitting diodes (LED), that are mounted to face plate 16 to visually display which time period has been selected by movement of rocker 20. Alternatively, indicator 38 may comprise a single LED or indicator which is capable of illuminating with two discrete colors, or even a speaker for audibly chirping when on “on” event is detected.

As seen in FIG. 3, microprocessor 32 is electrically interconnected to rocker 20 by electrical contacts 40 and 42 positioned under first and second positions 24 and 26, respectively, which act as “on” and “off” buttons. Microprocessor 32 is further interconnected to a relay 34 for engaging or disengaging an electrical load from electrical circuit 12.

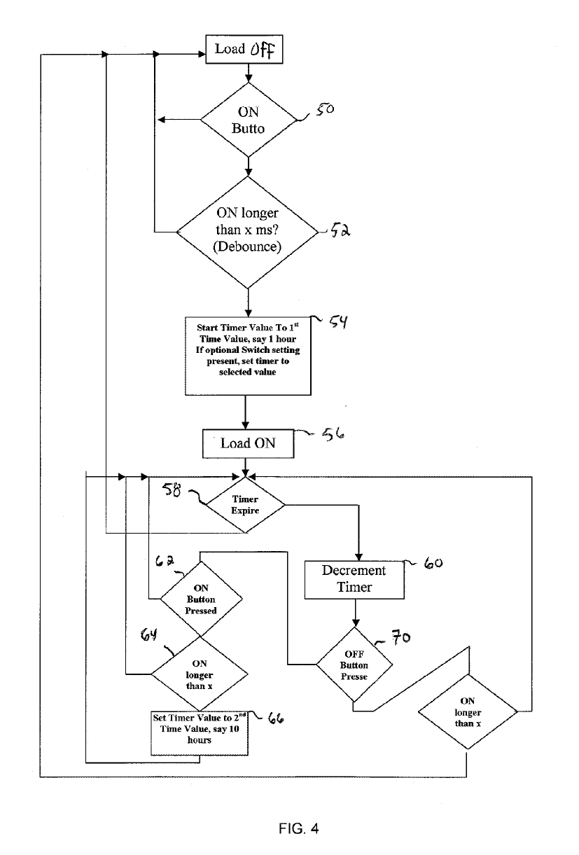

Referring to FIG. 4, microprocessor 32 determines whether rocker 20 has been engaged to trigger an “on” event 50. If so, microprocessor 32 runs a short debounce routine 52 to eliminate false signals. If an “on” event passes the debounce routine 52, microprocessor sets a first predetermined time period 54 and applies a load 56 to electrical circuit 12. Timer is checked for expiration 58 and, if the timer has not expired, the timer is decremented 60. Microprocessor 32 also checks to see whether a second “on” event has occurred 62 during first predetermined time period 54 and, if so 64, a second timer is set and decremented as time passes 66. When microprocessor 32 determines that first timer has expired 58, second timer is also checked for expiration 58. When both timers have expired, microprocessor 32 removes the load from electrical circuit 12. If microprocessor detects an “off” event 70, timer are reset to zero and the load is removed from electrical circuit 12.

What is claimed is:

1. An electrical switch, comprising:
a housing including circuitry for applying a load to an electrical circuit;
a rocker interconnected to said housing for movement between a first position, a neutral position, and a second position;
wherein movement of said rocker into said first position causes said circuitry to apply said load to said electrical circuit for a first predetermined period of time.

2. The switch of claim 1, further including a spring biasing said rocker into said neutral position.

3. The switch of claim 2, wherein subsequent movement of said rocker into said first position causes said circuitry to apply said load to said electrical circuit for a second predetermined period of time.

4. The switch of claim 3, wherein movement of said rocker into said second position causes said circuitry to remove said load from said electrical circuit.

5. The switch of claim 3, further comprising a first timer for measuring said first predetermined period of time.

6. The switch of claim 5, further comprising a second timer for measuring said second predetermined period of time.

7. An electrical switch, comprising:
a housing including circuitry for applying a load to an electrical circuit, wherein said circuitry includes a first timer for measuring a first period of time;
a rocker interconnected to said housing for movement between a first position, a neutral position, and a second position, wherein movement of said rocker into said first position causes said circuitry to apply said load to said electrical circuit for said first period of time; and
means for adjusting said first period of time interconnected to said timer.

8. The switch of claim 7, further including a spring biasing said rocker into said neutral position.

9. The switch of claim 7, wherein said circuitry includes a second timer for measuring a second period of time.

10. The switch of claim 9, wherein movement of said rocker into said first position prior to expiration of said first period of time causes said circuitry to apply said load to said electrical circuit for said second period of time.

11. The switch of claim 10, wherein movement of said rocker into said second position prior to the expiration of said first period of time and said second period of time causes said circuitry to remove said load from said electrical circuit.

12. The switch of claim 7, further comprising a light emitting diode that is illuminated when said load is being applied for said first period of time.

13. The switch of claim 10, further comprising a first light emitting diode that is illuminated when said load is being applied for said first period of time and a second light emitting diode that is illuminated when said load is being applied for said second period of time.

14. The switch of claim 7, wherein said circuitry comprises a microprocessor interconnected to a relay.

15. The switch of claim 14, wherein said circuitry comprises a microprocessor interconnected to a triac.

16. An electrical switch, comprising:
a housing including circuitry for selectively applying and removing a load to an electrical circuit, wherein said circuitry includes a first timer for measuring a first period of time and a second timer for measuring a second period of time;
a rocker interconnected to said housing for movement between a first position, a neutral position, and a second position;
a spring biasing said rocker into said neutral position;
wherein movement of said rocker into said first position causes said circuitry to apply said load to said electrical circuit for said first period of time; and
wherein movement of said rocker into said first position during said first period of time caused said circuitry to apply said load to said electrical circuit for said second period of time.

17. The switch of claim 16, further comprising an indicator that is illuminated during said first period of time.

18. The switch of claim 17, wherein said indicator is illuminated during said second period of time.

19. The switch of claim 18, wherein said indicator is illuminated with a first color during said first period of time and is illuminated with a second color during said second period of time.

20. The switch of claim 19, wherein said first timer and said second timer are adjustable.
